(19) United States
(12) Patent Application Publication
(10) Pub. No.: US 2025/0023398 A1
(43) Pub. Date: Jan. 16, 2025

(54) PERMANENT MAGNET ASSISTED SYNCHRONOUS RELUCTANCE MOTORS

(71) Applicant: ABB SCHWEIZ AG, Baden (CH)

(72) Inventors: Darren Tremelling, Raleigh, NC (US); Elio Perigo, Raleigh, NC (US); Sheng Zhong, Raleigh, NC (US)

(21) Appl. No.: 18/899,326

(22) Filed: Sep. 27, 2024

Related U.S. Application Data
(63) Continuation of application No. PCT/IB2022/000173, filed on Mar. 30, 2022.

(51) Int. Cl. H02K 1/02; H02K 1/27; H02K 15/03

(52) U.S. Cl. CPC H02K 1/02; H02K 1/27; H02K 15/03; H02K 2215/00

(57) ABSTRACT

A permanent magnet rotor can include a rotor body and at least one magnet. The rotor body can include at least one rotor cavity. The at least one magnet includes, in part, Mn—Bi particles and the at least one magnet can be either a sintered magnet or a polymer bonded magnet. The at least one magnet can be located, at least partially, in the at least one rotor cavity. Further, the at least one magnet can be installed in the at least one rotor cavity after forming the at least one magnet or the at least one magnet can be formed in the at least one rotor cavity using a mold. Moreover, the polymer bonded magnet can include a composite of polymer matrix and Mn—Bi particles.

### FIELD

The present disclosure relates to the field of electrical machines, and, more particularly, to permanent magnet rotors.

### BACKGROUND

Synchronous reluctance motors are machines in which, at steady state, shaft rotation is synchronized with the supply current frequency. In such machines, the stator field rotates with the line current, and the rotor rotates at the same rate as the stator field. Typically, synchronous reluctance machines use ferrites or Nd—Fe—B (Neodymium) as the magnetic material in the rotor. Ferrites present lower intrinsic coercivity and can cost less than other commercially available compounds, while Neodymium can be implemented when ferrites cannot be used due to higher requirements against demagnetization due to the intrinsic coercivity of Neodymium-based magnets being at least twice the value of ferrites. However, the cost to manufacture rotors made with Neodymium-based magnets can be significantly higher than with ferrites. In addition, although Neodymium-based magnetic materials may be diluted with organic binders, this merely results in a minor change in cost. Accordingly, improved rotors are desirable.

### SUMMARY

To address or at least partially address the above and other potential problems, embodiments of the present disclosure provide a permanent magnet rotor for synchronous motors.

In some embodiments, a permanent magnet rotor includes a rotor body, including at least one rotor cavity; and at least one magnet at least partially disposed in the at least one rotor cavity, including: Mn—Bi particles, wherein the Mn—Bi particles form at least a portion of the at least one magnet.

In some embodiments, the at least one magnet includes a sintered magnet.

In some embodiments, the at least one magnet includes a polymer bonded magnet, wherein the polymer bonded magnet includes a composite of a polymer matrix and the Mn—Bi particles.

In some embodiments, the polymer matrix includes a thermoplastic.

In some embodiments, the polymer matrix includes a thermosetting polymer.

In some embodiments, the polymer matrix further includes: an additive, wherein the additive includes a lubricant, a plasticizer, and a combination thereof, wherein the additive reduces a polymer melt viscosity to reduce a processing temperature.

In some embodiments, the rotor body further includes a plurality of stacked laminations, and wherein each of the plurality of stacked laminations further includes the at least one rotor cavity.

In some embodiments, the permanent magnet rotor further includes: wherein a melting point of the Mn—Bi particles includes a predetermined temperature; wherein forming the at least one magnet includes heating the Mn—Bi particles at a temperature range based at least in part on the predetermined temperature; and wherein the temperature range includes a temperature from 180° C. to 280° C.

In some embodiments, the at least one magnet includes a hard magnetic material having an intrinsic coercivity of at least 400 kA/m.

In some embodiments, the rotor body includes a magnetic anisotropy greater than 3.

In some embodiments, a method for forming a permanent magnet rotor includes: obtaining a rotor body, the rotor body including at least one rotor cavity; obtaining Mn—Bi particles; forming at least one magnet, by applying heat to the Mn—Bi particles, at a temperature range based at least partially on a predetermined temperature; and positioning the at least one magnet at the at least one rotor cavity.

In some embodiments, the at least one magnet includes a sintered magnet, and wherein forming the at least one magnet further includes: applying a magnetic alignment field to the Mn—Bi particles; and sintering the Mn—Bi particles at the temperature range to form the at least one magnet.

In some embodiments, the at least one magnet includes a polymer bonded magnet, and wherein forming the polymer bonded magnet further includes: obtaining a polymer matrix; compounding the polymer matrix and the Mn—Bi particles to form a composite; obtaining a mold, wherein the mold includes a mold cavity to receive the rotor body; positioning the rotor body into the mold cavity; filling the at least one rotor cavity with the composite; and applying a magnetic alignment field to the composite prior to solidification of the polymer matrix.

In some embodiments, forming the polymer bonded magnet further includes: applying a magnetizing field to the at least one magnet disposed in the at least one rotor cavity.

In some embodiments, the polymer matrix is a thermoplastic.

In some embodiments, the polymer matrix is a thermosetting polymer.

In some embodiments, the method further includes: wherein the predetermined temperature includes a melting point of the Mn—Bi particles; wherein forming the at least one magnet includes applying heat to the Mn—Bi particles at a temperature range based at least in part on the predetermined temperature; and wherein the temperature range includes a temperature from 180° C. to 280° C.

In some embodiments, a system includes: a rotor body including: a plurality of stacked laminations; wherein each of the plurality of stacked laminations further includes at least one rotor cavity; and at least one magnet disposed proximate to the at least one rotor cavity, the at least one magnet having a melting point at a predetermined temperature and including in part: Mn—Bi particles; wherein the Mn—Bi particles form the at least one magnet by receiving an electromagnetic field at a temperature range based in part on the predetermined temperature; wherein the temperature range includes a temperature from 180° C. to 280° C.

In some embodiments, the at least one magnet includes a sintered magnet.

In some embodiments, the at least one magnet includes a polymer bonded magnet, wherein the at least one magnet includes a composite of a polymeric matrix and the Mn—Bi particles.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a top view of a permanent magnet rotor, according to some embodiments.

FIG. 2 is a perspective view of the permanent magnet rotor, according to some embodiments.

FIG. 3 is a J×H curve of the at least one magnet, according to some embodiments.

FIG. 4 is a flowchart of a method, according to some embodiments.

FIG. 5 is a flowchart of the method, according to some embodiments.

FIG. 6 is a flowchart of the method, according to some embodiments.

FIG. 7 is a flowchart of the method, according to some embodiments.

### DETAILED DESCRIPTION

Permanent magnets implemented in assisted synchronous reluctance machines, including ferrites or Neodymium-based magnets, preferably have a remanence of at least 30-40% of the airgap flux density to enhance the machine power factor, the resultant reduction in current, and improvement of power density. Ferrites present an intrinsic coercivity between 250 kA/m and 450 kA/m and present lower costs among commercially available compounds. Neodymium-based magnets can be typically implemented when ferrites cannot be used due to higher requirements against demagnetization since the intrinsic coercivity of Neodymium-based magnets is typically greater than ferrites. However, the cost of Neodymium-based magnets is significantly greater than that of ferrites

Currently available machines implement either ferrites or Neodymium-based magnets, either in sintered or bonded form in the rotor. For smaller motors, the availability of ferrites is seen to mitigate both material and manufacturing costs. However, while sintered ferrites may be used in magnet assisted synchronous reluctance machines up to a certain frame size, ferrites may not be a viable option for larger machines due to the lower intrinsic coercivity of ferrites. Thereby resulting in increased costs of implementing Neodymium-based magnets in the rotor.

Typical magnet assisted reluctance motors, induction motors in cast frames, and induction motors in fabricated frames can have near comparable magnetic loading at frame sizes between 80 mm to 1000 mm due to magnetic saturation in the lamination material, with airgap flux density a fraction of saturation values. Further, based on the electric loading of these same three motor types, ferrite coercivity capabilities shall be exceeded in the range of 250-315 mm frame sizes, above which a magnet with higher intrinsic coercivity may be needed where the overall magnetic field intensity may be proportional to the electrical loading of the stator. Therefore, the permanent magnet rotor 100 in the present embodiment can provide an alternative for magnet assisted reluctance motors of varying frame sizes.

Hereinafter, the permanent magnet rotor 100 and the method for forming the permanent magnet rotor 100 involved in various embodiments of the present invention will be illustrated based on the drawings.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment,” “in other embodiments,” and “in some other embodiments” as used herein do not necessarily refer to a different embodiment, although it may. All embodiments of the disclosure are intended to be combinable without departing from the scope or spirit of the disclosure.

As used herein, the term “intrinsic coercivity” can be defined as a material's resistance to demagnetization. In other words, the intrinsic coercivity is the intensity of the applied magnetic field needed to demagnetize the magnetic material driven to saturation by an opposing field and can be expressed in Tesla (T) or kA/m.

As used herein, the term “remanence” can be defined as the measure of the magnetization of a magnetic material once exposed to a magnetizing field of magnitude to magnetically saturate the magnet.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, when describing structural components, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

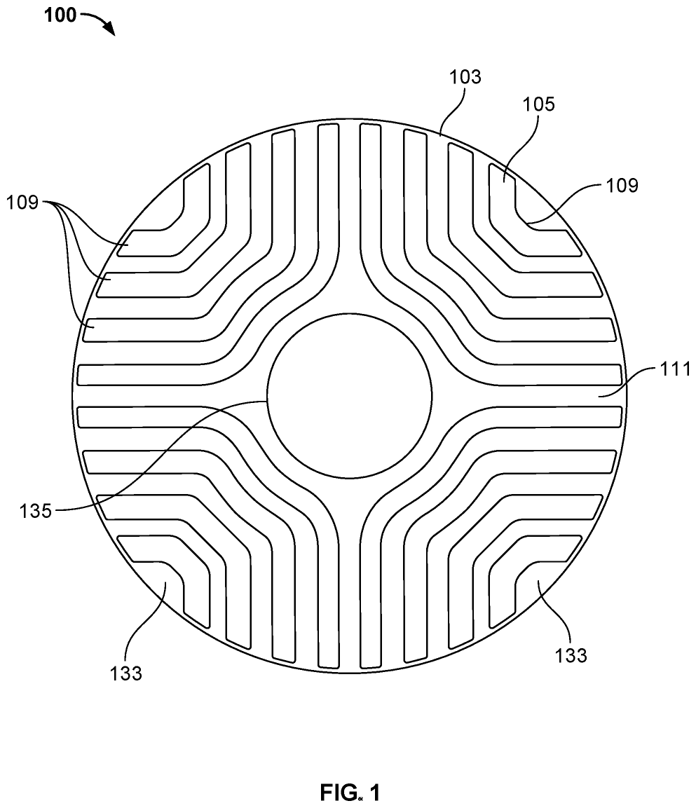

FIG. 1 is a top view of a permanent magnet rotor 100, according to some embodiments. The permanent magnet rotor 100 can be configured to be installed in a synchronous motor. In some embodiments, the permanent magnet rotor 100 can include a rotor body 103 and at least one magnet 105. In some embodiments, the rotor body 103 can be installed in the synchronous motor and can include at least one rotor cavity 109. In some embodiments, the at least one magnet 105 can be disposed in the at least one rotor cavity 109. In some embodiments, each of the at least one rotor cavity 109 can include the at least one magnet 105. In some embodiments, the number of the at least one rotor cavity in the rotor body 103 can exceed the number of at least one magnet 105 in the rotor body 103. In some embodiments, the number of the at least one magnet 105 can be based in part on the desired characteristics of the permanent magnet rotor 100, the synchronous motor, other factors, and a combination thereof.

In some embodiments, the at least one magnet 105 can include, at least in part, Mn—Bi particles. In some embodiments, the at least one magnet 105 can include Mn—Bi particles, organic binders, inorganic binders, antioxidants, fillers, additives, other materials, and combinations thereof. In some embodiments, the Mn—Bi particles can at least partially form a magnet powder. In some embodiments, the magnet powder can be diluted with organic binders, inorganic binders, fillers, additives, and combinations thereof. In some embodiments, the Mn—Bi particles can be round, rod-like, layered stacks, or any irregular structures. In some embodiments, the composition of the at least one magnet can vary depending on the applications and service condition. In some embodiments, the at least one magnet 105 can possess an intrinsic coercivity comparable to Neodymium-based magnets as will be further discussed below.

In some embodiments, the at least one magnet 105 can be a sintered magnet. In some embodiments, sintering the Mn—Bi particles can include forming a body of the at least one magnet 105. In some embodiments, forming the at least one magnet 105 can include applying a magnetic alignment field to the Mn—Bi particles, and then sintering the Mn—Bi particles to form a body of the at least one magnet 105. Therefore, in some embodiments, forming the sintered at least one magnet 105 can include applying a orienting magnetic alignment field to the Mn—Bi particles to orient the Mn—Bi particles before the sintering process. In some embodiments, the at least one magnet 105 can be installed onto the rotor body 103 after orienting and sintering the at least one magnet 105.

In some embodiments, the at least one magnet 105 can be a polymer bonded magnet. In some embodiments, the at least one magnet 105 can include a polymer matrix (i.e., a polymeric binder) and the Mn—Bi particles. In some embodiments, the polymer matrix and the Mn—Bi particles can be combined to form a composite. The at least one magnet 105 can fill the at least one rotor cavity 109 by any of a plurality of means of installing the at least one magnet into the at least one rotor cavity. In some embodiments, the at least one magnet 105 can be formed by filling the at least one rotor cavity 109 with the composite to form the at least one magnet 105. In some embodiments, the at least one magnet 105 can be formed by obtaining a mold. An interior of the mold can be defined by a mold cavity to accommodate the rotor body 103. The rotor body 103 can be positioned in the mold cavity such that the composite can fill a void defined, at least in part, by the at least one rotor cavity 109 and at least partially an interior surface of the mold cavity. In some embodiments, the composite can fill the at least one rotor cavity 109 such that the body of the at least one magnet 105 can be defined, at least in part, by a combination of a surface of the at least one rotor cavity 109 and at least a portion of the interior surface of the mold cavity at the at least one rotor cavity 109. When the body of the at least one magnet 105 freezes, the body of the at least one magnet 105 can take the shape defined, at least in part, by the at least one rotor cavity 109 and at least a portion of the interior surface of the mold cavity. In some embodiments, the body of the at least one magnet 105 can be formed by a combination of the surface of the at least one rotor cavity 109, the interior surface of the mold cavity, and an injection molding closing plate.

In some embodiments, the orienting magnetic alignment field can be applied to the composite during a filling of the composite at the at least one rotor cavity 109. In some embodiments, the orienting magnetic alignment field can be applied to the composite after the composite has filled the at least one rotor cavity 109 in the mold. In some embodiments, the orienting magnetic alignment field can be applied to the composite prior to the composite freezing, and prior to a temperature of the composite falling below a set temperature when the magnetic materials of the body can no longer be oriented.

In some embodiments, a magnetizing field can be applied to the at least one magnet 105 and the rotor body after forming the at least one magnet 105. In some embodiments, the magnetizing field can be applied to the rotor body and the mold. In other embodiments, the magnetizing field can be applied to the rotor body after the rotor body has been removed from the mold. In some embodiments, the magnetizing field can be applied to the at least one magnet 105 after freezing of the at least one magnet 105 where the composite has hardened.

In some embodiments, the polymer matrix can be a thermoplastic matrix. Consequently, in some embodiments, the composite can be a thermoplastic composite. The thermoplastic composite can form at least a portion of the at least one magnet 105 by injection molding. In some embodiments, the thermoplastic composite can include, but may not be limited to, polyolefins, such as polypropylene, polyethylene, low density polyethylene (LDPE), high density polyethylene (HDPE), acetal and ketal-based polymers and copolymers, polyesters (e.g. polyethylene terephthalate, polybutylene terephthalate), polycarbonate, polystyrene, polyether sulfone (PESU), polyphenylene sulfone (PPSU), polysulfone, and polytetrafluoroethylene (PTFE). Other polymers can also be implemented, including but not limited to polylactic acid, ethylene vinyl acetate copolymer (EVA), polyvinyl chloride (PVC), polyetherimide (PEI), polyphenylene sulfide (PPS), polyether ether ketone (PEEK), polyphthalamide (PPA), polyoxymethylene (POM), phenolformaldehyd (PF), unsatured polyester (UP), polyurethane (PUR and PU), polyimide, polyamide, polyvinyl alcohol, polyvinylidene chloride, polyacrylonitrile and polyalkylene paraoxybenzoate. The polymer matrix can be a single polymer or any of a combination of these thermoplastics.

In some embodiments, the polymer matrix can be a thermosetting polymer matrix. Consequently, in some embodiments, the thermosetting polymer composite can form at least a portion of the at least one magnet 105 by transfer molding, compression molding, potting, and a combination thereof. The thermosetting polymer matrix can include, but may not be limited to, epoxy, polyesters, bulk molding compound (BMC), phenolics, polyisoprene, polybutadiene (butadiene rubber), styrene-butadiene rubber, acrylonitrile-butadiene copolymer, isobutylene-isoprene copolymer, ethylene-propylene copolymer, polychloroprene, polysulfide, polydimethyl siloxane (silicones), polyurethane, polyacrylate elastomer, chlorinated polyethylene, styrene-isoprene-styrene copolymer (SIS), styrene-butadiene-styrene copolymer (SBS),, ethylene-propylene-dienepolymer, and fluoroelastomers, including tetrafluoroethylene propylene, fluorosilicone, and perfluoroelastomer. The polymer matrix can be a single polymer or any of a combination of these thermosetting polymers.

In some embodiments, the at least one magnet 105 can be formed, at least in part, by heating the Mn—Bi particles. In some embodiments, the Mn—Bi particles can be heated with any of a plurality of heating processes including, but not limited to, resistive heating, inductive heating, frictional heating, conduction, convection, radiation, and a combination thereof. In some embodiments, the Mn—Bi particles can have a melting point at a predetermined temperature. In some embodiments, the predetermined temperature can be based in part on the melting point at which decomposition of the Mn—Bi particles hard magnetic phase results. In some embodiments, the melting point of the Mn—Bi particles can be approximately 260° C. In some embodiments, forming the at least one magnet 105 can include applying heat to the Mn—Bi particles at a temperature range based, in part, on the predetermined temperature. In some embodiments, forming the at least one magnet 105 can include applying heat to the Mn—Bi particles at a temperature range from 180° C. to 280° C. In some embodiments, forming the at least one magnet 105 can include applying heat to the Mn—Bi particles at a temperature range from 200° C. to 280° C.

In some embodiments, the Mn—Bi particles can be mixed with the organic binders, inorganic binders, other additives, and combinations thereof to raise or lower the temperature range at which the electromagnetic field can be applied to form the at least one magnet 105. In some embodiments, forming the at least one magnet 105 can include applying heat to the Mn—Bi particles at a temperature range from 210° C. to 280° C. In some embodiments, forming the at least one magnet 105 can include applying heat to the Mn—Bi particles at a temperature range from 220° C. to 280° C. In some embodiments, forming the at least one magnet 105 can include applying heat to the Mn—Bi particles at a temperature range from 230° C. to 280° C. In some embodiments, forming the at least one magnet 105 can include applying heat to the Mn—Bi particles at a temperature range from 240° C. to 280° C. In some embodiments, forming the at least one magnet 105 can include applying heat to the Mn—Bi particles at a temperature range from 250° C. to 280° C. In some embodiments, forming the at least one magnet 105 can include applying heat to the Mn—Bi particles at a temperature range from 260° C. to 280° C. In some embodiments, forming the at least one magnet 105 can include applying heat to the Mn—Bi particles at a temperature range from 200° C. to 270° C. In some embodiments, forming the at least one magnet 105 can include applying heat to the Mn—Bi particles at a temperature range from 200° C. to 260° C. In some embodiments, forming the at least one magnet 105 can include applying heat to the Mn—Bi particles at a temperature range from 200° C. to 250° C. In some embodiments, forming the at least one magnet 105 can include applying heat to the Mn—Bi particles at a temperature range from 200° C. to 240° C. In some embodiments, forming the at least one magnet 105 can include applying heat to the Mn—Bi particles at a temperature range from 200° C. to 230° C. In some embodiments, forming the at least one magnet 105 can include applying heat to the Mn—Bi particles at a temperature range from 200° C. to 220° C.

In some embodiments, the polymer matrix can be sensitive to temperature and oxidation. Therefore, in some embodiments, the polymer matrix can include an additive to, among other benefits, reduce a polymer melt viscosity and thus reduce the processing temperature when forming the at least one magnet 105. In some embodiments, the additive can be a lubricant, a plasticizer, an antioxidant, other agent, and a combination thereof. In some embodiments, the plasticizer additive can effectively reduce the compounding and molding temperatures for thermoplastics and can include di-n-butyl phthalate, tritolyl phosphate, trixylyl phosphate, di-iso-octyl adipate, iso-octyl ester, epoxidized soybean oil, and polypropylene sebacate. In some embodiments, the additive can include an antioxidant to reduce the oxidation in the polymer matrix as well as in the Mn—Bi particles. In some embodiments, the antioxidants can include hindered phenolics, phosphites/phosphonites, thiosynergists, metal deactivators, any antioxidant blends, and combinations thereof.

In some embodiments, the rotor body 103 can include the at least one rotor cavity 109. In some embodiments, a quantity and position of the at least one rotor cavity 109 in the rotor body 103 can be based, in part, on any of a plurality of characteristics including, but not limited to, rotor topology, rotor size, motor size, power rating, stator design, other characteristics, and a combination thereof. In some embodiments, the depth of the at least one rotor cavity 109 can be based, at least in part, on the desired rotor topology, size of the at least one magnet 105, other factors, and combinations thereof. In some embodiments, the at least one rotor cavity 109 can radially extend along the rotor body 103. In some embodiments, the at least one rotor cavity 109 can axially extend along the rotor body 103. In some embodiments, the at least one rotor cavity 109 can include, but not limited to, a recess, a channel, a bore, an aperture, other profiles, and a combination thereof, wherein the at least one rotor cavity 109 is at least partially defined by the rotor body 103. In some embodiments, the at least one rotor cavity 109 can be disposed in the rotor body 103, the boundary of the at least one rotor cavity 109 being substantially defined by the rotor body 103. Further, in some embodiments, the at least one rotor cavity 109 can include a plurality of shapes including, but not limited to circular, rounded, angular, straight, and any combination thereof. For example, in some embodiments, the at least one rotor cavity 109 can be axially disposed on a surface 111 of the rotor body 103, the at least one rotor cavity 109 having at least one magnet 105 disposed in the at least one rotor cavity 109 such that the at least one magnet 105 does not protrude beyond the surface 111 of the rotor body 103.

In some embodiments, the at least one magnet 105 can be shaped to complement the at least one rotor cavity 109. In some embodiments, the at least one magnet 105 can include any of a plurality of shapes independent of the at least one rotor cavity 109. In some embodiments, the at least one magnet 105 can be fully disposed in the at least one rotor cavity 109, wherein no portion of the at least one magnet 105 protrudes beyond a surface of the rotor body 103. In some embodiments, the at least one magnet 105 can at least partially protrude from the at least one rotor cavity 109. In some embodiments, the at least one magnet 105 can be formed before being installed onto the rotor body 103 and the at least one magnet 105 can be attached to the rotor body 103 by an adhesive, epoxy, bonding agents, and a combination thereof. In some embodiments, the at least one magnet 105 can be partially formed by being inserted into the at least one rotor cavity 109 and allowed to partially harden or fully harden in the at least one rotor cavity 109. In some embodiments, the shape of the at least one magnet 105 can be partially based on the shape of the at least one rotor cavity 109. In some embodiments, the at least one magnet 105 can be shaped such that the surface of the at least one magnet 105 does not extend beyond the surface of the rotor body 103 when the at least one magnet 105 is installed in the rotor body 103. In some embodiments, the at least one magnet 105 can extend beyond a surface of the rotor body 103 and a profile of the at least one rotor cavity 109. For example, but not limited to, when the polymer matrix of the at least one magnet 105 forms in the mold containing the rotor body 103, the profile of the at least one magnet 105 can be based on a combination of the at least one rotor cavity 109 and the at least one mold cavity.

In some embodiments, the rotor body 103 can include a plurality of poles 133. It is noted that both a quantity and a position of each of the plurality of poles 133 shown in the illustrative embodiments is exemplary and not intended to be limiting. In some embodiments, the rotor body 103 can include at least two poles. In some embodiments, the rotor body 103 can include four poles. In some embodiments, the rotor body 103 can include six poles. In some embodiments, the rotor body 103 can include eight poles. In some embodiments, the rotor body 103 can include more than eight poles. In some embodiments, the rotor body 103 can include ten poles. In some embodiments, the rotor body 103 can include twelve poles. In some embodiments, the rotor body 103 can include fourteen poles. In some embodiments, the rotor body 103 can include up to twenty-four poles. In some embodiments, the rotor body 103 can include more than twenty-four poles.

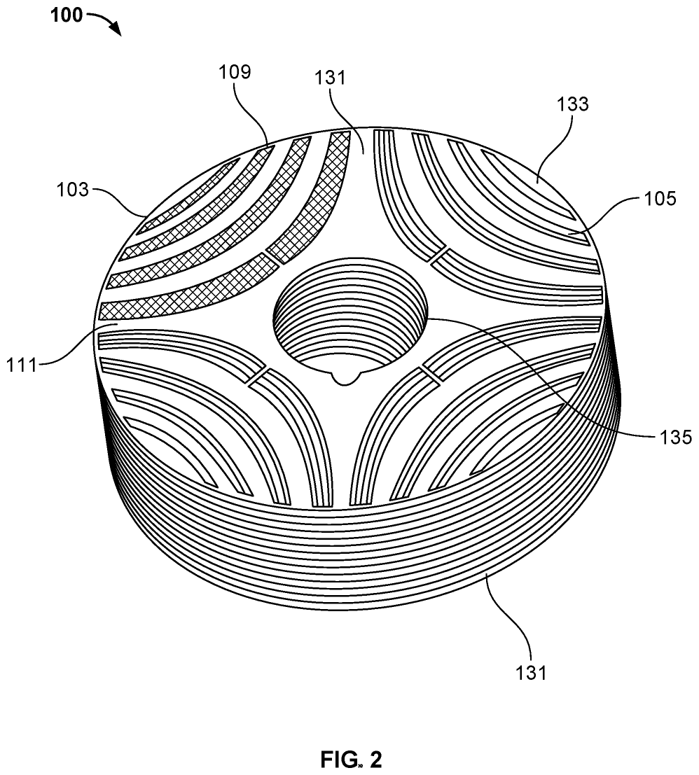

FIG. 2 is a perspective view of the permanent magnet rotor 100, according to some embodiments. The permanent magnet rotor 100 shown in the figures are an illustrative embodiment and is not intended to be limiting. In some embodiments, the rotor body 103 can include stacked laminations 131. In some embodiments, the rotor body 103 can include a plurality of stacked laminations 131. In some embodiments, the number of stacked laminations 131 can be based on a plurality of factors including, but not limited to, rotor topology, motor design, power requirements, stator design, air gap, other operating characteristics, and a combination thereof.

In some embodiments, each of the stacked lamination 131 can include the at least one rotor cavity 109. In some embodiments, each of the stacked laminations 131 can include the same number of rotor cavities 109, a different number of rotor cavities 109, and combinations thereof. In some embodiments, a position of each of the at least one rotor cavity 109 can be based, in part, on the number of desired poles in the rotor body 103. Therefore, each of the stacked laminations 131 can include a plurality of poles 133 defined in part by the position of the rotor cavities 109.

In some embodiments, rotor body 103 can include a bore 135 that axially extends through a central portion of the rotor body 103. In some embodiments, the bore 135 can extend through each of the stacked laminations 131 that can form the rotor body 103. In some embodiments, the bore 135 can accommodate a rotor shaft, other components, and combinations thereof.

The rotor body 103 can be any of a plurality of rotor diameters based, at least in part, on the size of the motor, the power rating of the motor, air gap, air gap flux density, other design and operational characteristics, and combinations thereof. In some embodiments, the rotor diameter can be up to 3000 mm. In some embodiments, the rotor diameter can range from 200 mm to 3000 mm. In some embodiments, the rotor diameter can range from 300 mm to 3000 mm. In some embodiments, the rotor diameter can range from 400 mm to 3000 mm. In some embodiments, the rotor diameter can range from 500 mm to 3000 mm. In some embodiments, the rotor diameter can range from 1000 mm to 3000 mm. In some embodiments, the rotor diameter can range from 1500 mm to 3000 mm. In some embodiments, the rotor diameter can range from 2000 mm to 3000 mm. In some embodiments, the rotor diameter can range from 2500 mm to 3000 mm.

In some embodiments, the at least one magnet 105 can include a remanence of 30-80% of an airgap flux density. In some embodiments, the permanent magnet rotor 100 can include a remanence of 40-80% of the airgap flux density. In some embodiments, the permanent magnet rotor 100 can include a remanence of 50-80% of the airgap flux density. In some embodiments, the permanent magnet rotor 100 can include a remanence of 30-70% of the airgap flux density. In some embodiments, the permanent magnet rotor 100 can include a remanence of 30-60% of the airgap flux density. In some embodiments, the permanent magnet rotor 100 can include a remanence of 30-50% of the airgap flux density.

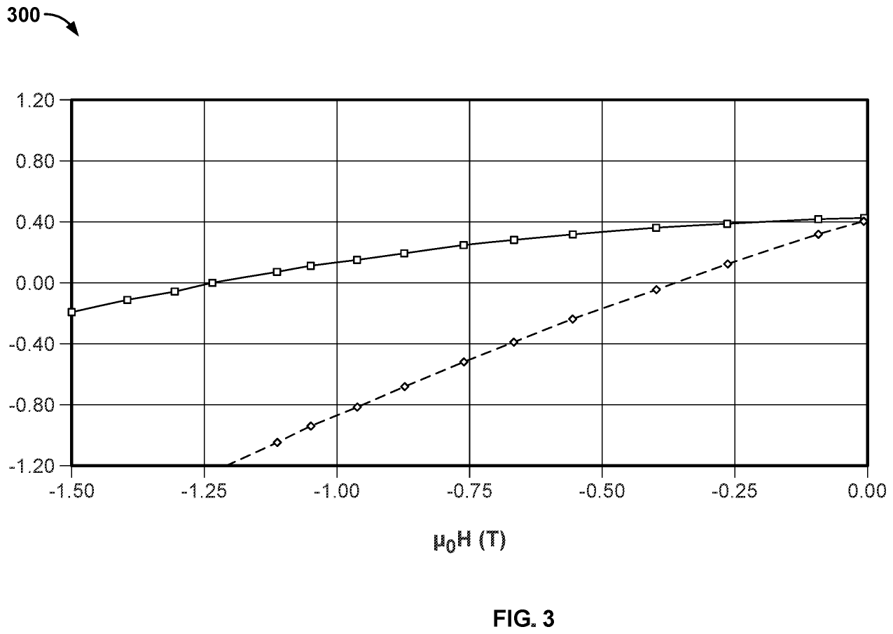

FIG. 3 is a J×H curve 300 of the at least one magnet 105 formed from the polymer matrix and the Mn—Bi particles, according to some embodiments. It is noted that the J×H curve 300 shown in FIG. 3 is an illustrative embodiment of the at least one magnet 105 and is not intended to be limiting. In some embodiments, the intrinsic coercivity of the at least one magnet 105 can be at least 400 kA/m. In some embodiments, the intrinsic coercivity of the at least one magnet 105 can be at least 500 kA/m. In some embodiments, the intrinsic coercivity of the at least one magnet 105 can be at least 600 kA/m. In some embodiments, the intrinsic coercivity of the at least one magnet 105 can be at least 700 kA/m. In some embodiments, the intrinsic coercivity of the at least one magnet 105 can be at least 800 kA/m. In some embodiments, the intrinsic coercivity of the at least one magnet 105 can be at least 1000 kA/m. In some embodiments, the intrinsic coercivity of the at least one magnet 105 can be up to 1200 kA/m.

In some embodiments, the orienting magnetic alignment field can be applied to the body of the at least one magnet 105 to form, in part, the at least one magnet 105. The orienting magnetic alignment field applied to develop magnetic anisotropy should be high enough to drive a magnetic material to saturation. In some embodiments, the orienting magnetic alignment field applied to the at least one magnet 105 to drive the at least one magnet 105 to saturation can be greater than that for ferrites but less than that for Neodymium-based magnets. In some embodiments, the body of the at least one magnet 105 can be magnetically saturated with the magnetic alignment field of 1-2 T. In some embodiments, the body of the at least one magnet 105 can be magnetically saturated with the magnetic alignment field of 2 T and greater to fully saturate the at least one magnet 105.

In some embodiments, a magnetizing field can be applied to the body of the at least one magnet 105 after positioning the at least one magnet 105 at the at least one rotor cavity 109. In some embodiments, the magnetizing field can be applied to the body of the at least one magnet 105 after solidification of the body of the at least one magnet 105 at the at least one rotor cavity 109. In some embodiments, the magnetizing field applied to the at least one magnet 105 can be from 1 T to 2 T. In some embodiments, the magnetizing field applied to the at least one magnet 105 can be from 2 T to 3 T. In some embodiments, the magnetizing field can be at least 3 T.

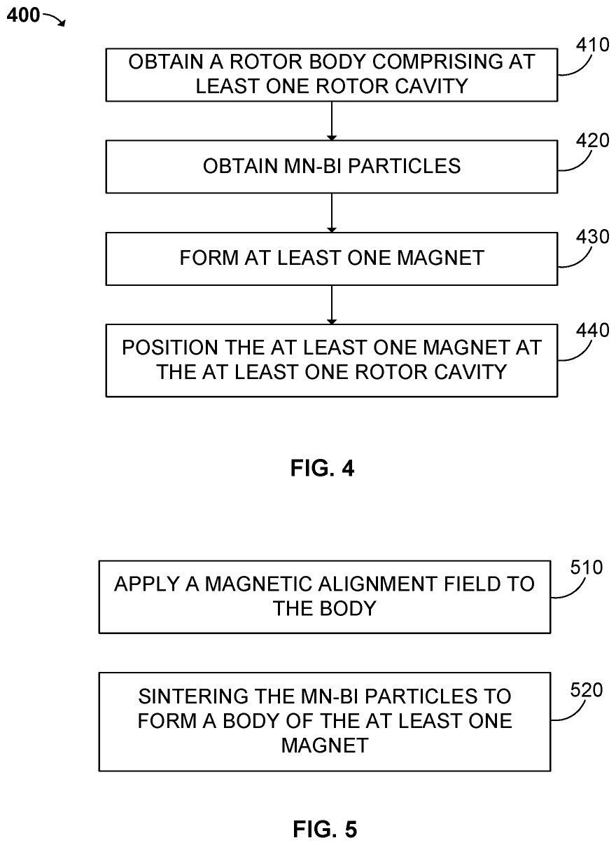

FIGS. 4-7 are flowcharts of a method 400, according to some embodiments. The method 400 generally relates to forming a permanent magnet rotor 100.

Referring to FIG. 4, at 410, the method 400 includes obtaining a rotor body 103. The rotor body 103 can include at least one rotor cavity 109, the at least one rotor cavity 109 being disposed on the rotor body 103 to receive the at least one magnet 105. At 420, the method 400 includes obtaining Mn—Bi particles. In some embodiments, the Mn—Bi particles may be a magnetic powder. At 430, the method 400 includes forming the at least one magnet 105. In some embodiments, forming the at least one magnet 105 can include applying heat to the Mn—Bi particles. In some embodiments, the heat applied to the Mn—Bi particles can be at, or within, a temperature range. In some embodiments, the temperature range can be based, at least in part, on a predetermined temperature. In some embodiments, the predetermined temperature can be a melting point at which decomposition of the Mn—Bi particles hard magnetic phase results.

At 440, the method 400 includes positioning the at least one magnet 105 at the at least one rotor cavity 109. In some embodiments, the body of the at least one magnet 105 can be formed prior to positioning the at least one magnet 105 at the at least one rotor cavity 109. In some embodiments, the body of the at least one magnet 105 can be formed during positioning of the at least one magnet 105 at the at least one rotor cavity 109.

Referring to FIG. 5, in some embodiments, the at least one magnet 105 can be a sintered magnet. In some embodiments, at 510, forming the at least one magnet 105 can include applying a magnetic alignment field to the Mn—Bi particles. The magnetic alignment field can orient the Mn—Bi particles while forming the at least one magnet 105. In some embodiments, at 520, forming the at least one magnet 105 can include sintering the Mn—Bi particles at the temperature range to form the body of the at least one magnet 105. Sintering the at least one magnet 105 can harden the magnetic materials to form the body of the at least one magnet 105.

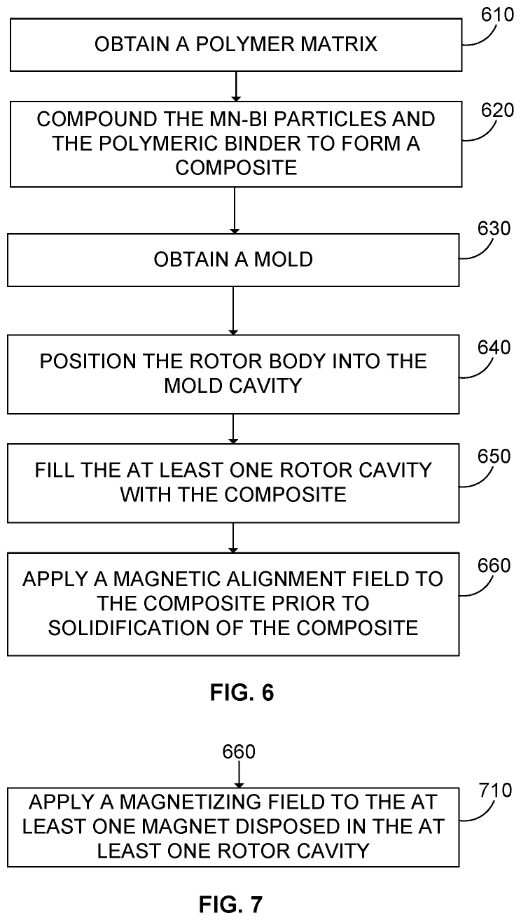

Referring to FIG. 6, in some embodiments, the at least one magnet 105 can be a polymer bonded magnet. In some embodiments, at 610, forming the at least one magnet 105 can include obtaining a polymer matrix. The polymer matrix can be a polymer binder. In some embodiments, at 620, forming the at least one magnet 105 can include compounding the polymer matrix and the Mn—Bi particles to form a composite. In some embodiments, at 630, forming the at least one magnet 105 can include obtaining a mold. The mold can include a mold cavity. In some embodiments, a shape of the mold cavity can be the shape and dimensions of the rotor body. In some embodiments, the mold cavity can substantially be the shape as the rotor body to allow the composite to be filled into the at least one rotor cavity 109. In some embodiments, at 640, forming the at least one magnet 105 can include positioning the rotor body in the mold cavity. In some embodiments, at 650, forming the at least one magnet 105 can include filling the at least one rotor cavity 109 with the composite. In some embodiments, filling the at least one rotor cavity 109 can include filling the mold cavity such that the composite can be directed into the at least one rotor cavity 109.

In some embodiments, at 660, forming the at least one magnet 105 can include applying a magnetic alignment field to the composite. In some embodiments, the magnetic alignment field can be applied to the composite when the composite temperature is near the filling temperature. In some embodiments, the magnetic alignment field can be applied to the composite prior to solidification of the composite. In some embodiments, the magnetic alignment field can be applied as the composite fills the at least one rotor cavity 109. In some embodiments, the magnetic alignment field can be applied to the composite once the composite fills the at least one rotor cavity 109 and prior to the composite cooling. In some embodiments, the magnetic alignment field can be applied to the composite prior to the composite cooling below a set temperature. The composite receives the magnetic alignment field prior to solidification or else the Mn—Bi particles can be mechanically locked and can interfere with orientation of the Mn—Bi particles. In some embodiments, the magnetic alignment field applied to the body of the at least one magnet 105 can be from 1 T to 2 T. In some embodiments, the magnetic alignment field applied to the body of the at least one magnet 105 can be from 2 T to 3 T. In some embodiments, the magnetic alignment field applied to the body of the at least one magnet 105 can be greater than 3T.

Referring to FIG. 7, in some embodiments, at 710, forming the at least one magnet 105 can further include applying a magnetizing field to the at least one magnet 105 disposed in the at least one rotor cavity 109. In some embodiments, the magnetic alignment field, at 660 (FIG. 6), can be a first magnetizing field and the magnetizing field can be a second magnetic field applied to the at least one magnet 105 after the at least one magnet 105 solidifies in the at least one rotor cavity 109. In some embodiments, the magnetizing field applied to the body of the at least one magnet 105 can range from 1 T to 2 T. In some embodiments, the magnetizing field applied to the body of the at least one magnet 105 can range from 2 T to 3 T. In some embodiments, the magnetizing field applied to the body of the at least one magnet 105 can be at least 3 T.

### Aspects

Various Aspects are described below. It is to be understood that any one or more of the features recited in the following Aspect(s) can be combined with any one or more other Aspect(s).

In some aspects, the techniques described herein relate to a permanent magnet rotor, including: a rotor body, including: at least one rotor cavity; and at least one magnet at least partially disposed in the at least one rotor cavity, including: Mn—Bi particles, wherein the Mn—Bi particles form at least a portion of the at least one magnet.

In some aspects, the techniques described herein relate to a permanent magnet rotor, wherein the at least one magnet includes a sintered magnet.

In some aspects, the techniques described herein relate to a permanent magnet rotor, wherein the at least one magnet includes a polymer bonded magnet, wherein the polymer bonded magnet includes a composite of a polymer matrix and the Mn—Bi particles.

In some aspects, the techniques described herein relate to a permanent magnet rotor, wherein the polymer matrix includes a thermoplastic.

In some aspects, the techniques described herein relate to a permanent magnet rotor, wherein the polymer matrix includes a thermosetting polymer.

In some aspects, the techniques described herein relate to a permanent magnet rotor, wherein the polymer matrix further includes: an additive, wherein the additive includes a lubricant, a plasticizer, and a combination thereof, wherein the additive reduces a polymer melt viscosity to reduce a processing temperature.

In some aspects, the techniques described herein relate to a permanent magnet rotor, wherein the rotor body further includes a plurality of stacked laminations, and wherein each of the plurality of stacked laminations further includes the at least one rotor cavity.

In some aspects, the techniques described herein relate to a permanent magnet rotor, further including: wherein a melting point of the Mn—Bi particles includes a predetermined temperature; wherein forming the at least one magnet includes heating the Mn—Bi particles at a temperature range based at least in part on the predetermined temperature; and wherein the temperature range includes a temperature from 180° C. to 280° C.

In some aspects, the techniques described herein relate to a permanent magnet rotor, wherein the at least one magnet includes a hard magnetic material having an intrinsic coercivity of at least 400 kA/m.

In some aspects, the techniques described herein relate to a permanent magnet rotor, wherein the rotor body includes a magnetic anisotropy greater than 3.

In some aspects, the techniques described herein relate to a method for forming a permanent magnet rotor, including: obtaining a rotor body, the rotor body including at least one rotor cavity; obtaining Mn—Bi particles; forming at least one magnet, by applying heat to the Mn—Bi particles, at a temperature range based at least partially on a predetermined temperature; and positioning the at least one magnet at the at least one rotor cavity.

In some aspects, the techniques described herein relate to a method, wherein the at least one magnet includes a sintered magnet, and wherein forming the at least one magnet further includes: applying a magnetic alignment field to the Mn—Bi particles; and sintering the Mn—Bi particles at the temperature range to form the at least one magnet.

In some aspects, the techniques described herein relate to a method, wherein the at least one magnet includes a polymer bonded magnet, and wherein forming the polymer bonded magnet further includes: obtaining a polymer matrix; compounding the polymer matrix and the Mn—Bi particles to form a composite; obtaining a mold, wherein the mold includes a mold cavity to receive the rotor body; positioning the rotor body into the mold cavity; filling the at least one rotor cavity with the composite; and applying a magnetic alignment field to the composite prior to solidification of the polymer matrix.

In some aspects, the techniques described herein relate to a method, wherein forming the polymer bonded magnet further includes: applying a magnetizing field to the at least one magnet disposed in the at least one rotor cavity.

In some aspects, the techniques described herein relate to a method, wherein the polymer matrix is a thermoplastic.

In some aspects, the techniques described herein relate to a method, wherein the polymer matrix is a thermosetting polymer.

In some aspects, the techniques described herein relate to a method, further including: wherein the predetermined temperature includes a melting point of the Mn—Bi particles; wherein forming the at least one magnet includes applying heat to the Mn—Bi particles at a temperature range based at least in part on the predetermined temperature; and wherein the temperature range includes a temperature from 180° C. to 280° C.

In some aspects, the techniques described herein relate to a system including: a rotor body including: a plurality of stacked laminations; wherein each of the plurality of stacked laminations further includes at least one rotor cavity; and at least one magnet disposed proximate to the at least one rotor cavity, the at least one magnet having a melting point at a predetermined temperature and including in part: Mn—Bi particles; wherein the Mn—Bi particles form the at least one magnet by receiving an electromagnetic field at a temperature range based in part on the predetermined temperature; wherein the temperature range includes a temperature from 180° C. to 280° C.

In some aspects, the techniques described herein relate to a system, wherein the at least one magnet includes a sintered magnet.

In some aspects, the techniques described herein relate to a system, wherein the at least one magnet includes a polymer bonded magnet, wherein the at least one magnet includes a composite of a polymeric matrix and the Mn—Bi particles.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A permanent magnet rotor, comprising:
a rotor body, comprising:
at least one rotor cavity; and
at least one magnet at least partially disposed in the at least one rotor cavity, comprising:
Mn—Bi particles,
wherein the Mn—Bi particles form at least a portion of the at least one magnet.

2. The permanent magnet rotor of claim 1, wherein the at least one magnet comprises a sintered magnet.

3. The permanent magnet rotor of claim 1, wherein the at least one magnet comprises a polymer bonded magnet,
wherein the polymer bonded magnet comprises a composite of a polymer matrix and the Mn—Bi particles.

4. The permanent magnet rotor of claim 3, wherein the polymer matrix comprises a thermoplastic.

5. The permanent magnet rotor of claim 3, wherein the polymer matrix comprises a thermosetting polymer.

6. The permanent magnet rotor of claim 3, wherein the polymer matrix further comprises:
an additive,
wherein the additive comprises a lubricant, a plasticizer, and a combination thereof,
wherein the additive reduces a polymer melt viscosity to reduce a processing temperature.

7. The permanent magnet rotor of claim 1, wherein the rotor body further comprises a plurality of stacked laminations, and wherein each of the plurality of stacked laminations further comprises the at least one rotor cavity.

8. The permanent magnet rotor of claim 1, further comprising:
wherein a melting point of the Mn—Bi particles comprises a predetermined temperature;
wherein forming the at least one magnet comprises heating the Mn—Bi particles at a temperature range based at least in part on the predetermined temperature; and
wherein the temperature range comprises a temperature from 180° C. to 280° C.

9. The permanent magnet rotor of claim 1, wherein the at least one magnet comprises a hard magnetic material having an intrinsic coercivity of at least 400 kA/m.

10. The permanent magnet rotor of claim 1, wherein the rotor body comprises a magnetic anisotropy greater than 3.

11. A method for forming a permanent magnet rotor, comprising:
obtaining a rotor body, the rotor body comprising at least one rotor cavity;
obtaining Mn—Bi particles;
forming at least one magnet, by applying heat to the Mn—Bi particles, at a temperature range based at least partially on a predetermined temperature; and
positioning the at least one magnet at the at least one rotor cavity.

12. The method of claim 11, wherein the at least one magnet comprises a sintered magnet, and wherein forming the at least one magnet further comprises:
applying a magnetic alignment field to the Mn—Bi particles; and
sintering the Mn—Bi particles at the temperature range to form the at least one magnet.

13. The method of claim 11, wherein the at least one magnet comprises a polymer bonded magnet, and wherein forming the polymer bonded magnet further comprises:
obtaining a polymer matrix;
compounding the polymer matrix and the Mn—Bi particles to form a composite;
obtaining a mold,
wherein the mold comprises a mold cavity to receive the rotor body;
positioning the rotor body into the mold cavity;
filling the at least one rotor cavity with the composite; and
applying a magnetic alignment field to the composite prior to solidification of the polymer matrix.

14. The method of claim 13, wherein forming the polymer bonded magnet further comprises:
applying a magnetizing field to the at least one magnet disposed in the at least one rotor cavity.

15. The method of claim 13, wherein the polymer matrix is a thermoplastic.

16. The method of claim 13, wherein the polymer matrix is a thermosetting polymer.

17. The method of claim 11, further comprising:
wherein the predetermined temperature comprises a melting point of the Mn—Bi particles;
wherein forming the at least one magnet comprises applying heat to the Mn—Bi particles at a temperature range based at least in part on the predetermined temperature; and
wherein the temperature range comprises a temperature from 180° C. to 280° C.

18. A system comprising:
a rotor body comprising:
a plurality of stacked laminations;
wherein each of the plurality of stacked laminations further comprises at least one rotor cavity; and
at least one magnet disposed proximate to the at least one rotor cavity, the at least one magnet having a melting point at a predetermined temperature and comprising in part:
Mn—Bi particles;
wherein the Mn—Bi particles form the at least one magnet by receiving an electromagnetic field at a temperature range based in part on the predetermined temperature;
wherein the temperature range comprises a temperature from 180° C. to 280° C.

19. The system of claim 18, wherein the at least one magnet comprises a sintered magnet.

20. The system of claim 18, wherein the at least one magnet comprises a polymer bonded magnet,
wherein the at least one magnet comprises a composite of a polymeric matrix and the Mn—Bi particles.
